(19) United States
(12) Patent Application Publication
(10) Pub. No.: US 2013/0266690 A1
(43) Pub. Date: Oct. 10, 2013

(54) METHOD FOR PRODUCING A BLUE CHEESE

(71) Applicant: Jean-Claude Guilloteau, Pelussin (FR)

(72) Inventor: Jean-Claude Guilloteau, Pelussin (FR)

(73) Assignee: FROMAGERIE GUILLOTEAU, Pelussin (FR)

(21) Appl. No.: 13/704,620

(22) PCT Filed: Jun. 16, 2011
(86) PCT No.: PCT/FR11/00348

§ 371 Date: Mar. 7, 2013

(30) Foreign Application Priority Data
Jun. 16, 2010 (FR) 1002538
Jun. 16, 2011 (FR) PCT/FR2011/000348

(51) Int. Cl. A23C 19/028

(52) U.S. Cl. CPC A23C 19/0285
USPC 426/37; 426/582

(57) ABSTRACT

A blue cheese and a process for producing blue cheese from a liquid pre-cheese obtained by complete ultrafiltration of milk, and of which the blue mold develops only in the needling holes.

### CROSS-REFERENCE TO RELATED APPLICATIONS

The present application is a National Stage Application of PCT International Application No. PCT/FR2011/000348 (filed on Jun. 16, 2011), under 35 U.S.C. §371, which claims priority to French Patent Application No. 1002538 (filed on Jun. 16, 2010), which are each hereby incorporated by reference in their respective entireties.

### FIELD OF THE INVENTION

The invention relates to a process for producing blue cheese from a liquid pre-cheese obtained by complete ultrafiltration of milk, and of which the blue mold develops only in the needling holes. The invention also relates to a blue cheese obtained by this process.

### BACKGROUND OF THE INVENTION

The production of cheese with internal blue mold is very old. There are many controlled designations of origin (“appellation d′origine contrôlée” or AOC), including Roquefort, Bleu des Causses, Bleu d'Auvergne, Fourme de Montbrison and Bleu de Sassenage. All of these cheeses have in common the fact that they were obtained by curdling milk, working the curd in a vat to enable the lactoserum to be removed and relatively firm curd grains to be obtained, and introducing it into suitable molds. The blue molds, in particular the penicillium roqueforti strain, which will develop inside and outside the cheese are mixed with the milk or the curd before molding.

It is important to obtain a relatively firm grain and not to press the cheese hard so that the cheese obtained by gathering grains in the old has many mechanical openings, cracks or cavities that will enable the blue mold to develop: the penicillium roqueforti molds are aerobic and need oxygen to develop.

Nevertheless, in spite of these internal openings, the blue can develop only if there is air entering these cavities after mold removal and salting. The salting may be performed either by salting in the mass of the curd (Fourme de Montbrison) or by salting the surface with dry salt, but never by brine, which would fill the internal openings.

After mold removal and salting, there is an operation of needling the blue cheese, which is intended to pierce the cheese relatively compactly so as to enable the internal mechanical openings to be exposed to air and the blue to develop. Such a process is described in the German patent DE 195,46,345 A1 (Vereinigte Coöperative Melkindustrie Coberco B.A.).

To produce a cheese with blue mold, it has also been proposed in the patent application FR 2,818,094 (D. Thuaire) to slice the curd cheese after a first pressing, to spread the blue mold on the slice faces, and to reassemble the cheese.

### SUMMARY OF THE INVENTION

The process in accordance with the invention involves a concentration, preferably complete, of the milk by ultrafiltration in order to obtain a liquid pre-cheese, a step of maturation of said liquid pre-cheese, with the addition of salt and blue mold, a step of molding in molds, followed by aging.

More specifically, the process in accordance with the invention involves a step of ultrafiltration on membranes of the milk, which replaces the traditional draining in the pierced mold; the ultrafiltration on membranes thus leads to an intermediate liquid product having the composition of the cheese. This intermediate product, called “liquid pre-cheese” is then molded so as to give it a shape, but, unlike the traditional process, this molding does not involve draining

Indeed, in the traditional process by draining in a pierced mold, the whey that leaves by draining carries a large part of the soluble proteins and soluble salts. The pierced mold gathers the curd grains; openings may naturally form in the cheese, in which the blue mold can grow.

However, the process in accordance with the invention, based on the use of a liquid pre-cheese, leads to an unctuous cheese, which does not form natural openings during subsequent steps, in particular during aging. Indeed, the ultrafiltration makes it possible to retain all of the soluble proteins (in particular lactalbumin and lactoglobulin), which, in the traditional process, leave in the lactoserum; these proteins make the structure of the cheese flexible and confer an unctuous character on it. This cheese, cast in a mold in the liquid state, does not develop natural openings. In the process in accordance with the invention, in order for the blue mold to be capable of developing, it is therefore necessary to artificially produce aeration channels in the cheese.

After curdling, the cheese is cooled in its mold, then removed from the mold. The cheese is then cooled at a temperature typically between 12° C. and 22° C. and channels are pierced in the cheese, with this piercing step being essential for the present invention.

The addition of blue mold can be performed either in the mass of the liquid cheese, before renneting, or during piercing (or after piercing) of the channels in the cheese.

If, for the sake of presentation, it is desired to produce a white-crusted cheese, after the needling of the cheese inoculated with blue mold, an aqueous or pre-cheese solution containing white mold, in particular penicillium candidum and geotrichum candidum is sprayed at the surface. If the inoculation with the blue mold has been performed in the mass of the cheese, the inoculation with the white mold must be performed within the ten hours following the mold removal, because there is competition between the white and blue molds.

The inoculation of the cheese with blue mold can also be performed during the piercing, for example by supplying the blue mold solution under pressure through a central conduit of the needle; thus, the solution, leaving the needle as it moves through the cheese, will inoculate the cheese with blue mold only in the hole created by the needle. The cheese surface may be inoculated as in the case above with mold and geotrichum candidum, but more safely because there will be no competition between the white and blue molds.

The invention relates firstly to a process for producing a molded cheese with internal blue mold using milk, and in particular pasteurized milk, in which:

(i) the milk is subjected to an ultrafiltration process that separates the milk into an aqueous permeate and a retentate, until a retentate called “liquid pre-cheese” is obtained, of which the volume is reduced to at least ⅓ and preferably to at least ¼, of the volume of the milk subjected to said ultrafiltration step;

(ii) said liquid pre-cheese is inoculated with a ferment capable of at least partially converting the lactose into lactic acid;

(iii) rennet is added and it is left to coagulate to obtain a cheese;

(iv) after mold removal, the cheese is needled by piercing a plurality of holes or channels so as to enable the blue mold to develop,

and in which process the blue mold is added introduced either in the mass of the liquid pre-cheese or in said holes or channels pierced in the cheese.

In one embodiment, at least some of the plurality of holes or channels pass through the cheese, so as to ensure sufficient air circulation. They may optionally intersect, but if the channels that intersect are arranged in the same plane, this intersection may plug the channels. Said holes or channels are advantageously pierced horizontally with respect to the external shape of the cheese; this shape is generally flattened (the case of a cylinder or brick-shaped segment). Their diameter is advantageously between 3 mm and 10 mm, and preferably between 4 mm and 7 mm.

The milk subjected to the ultrafiltration step (i) may be raw milk, but it may also be milk enriched with fat, for example by adding cream. Advantageously, the fat content is greater than 6%, and preferably greater than 8%; it may be 11 or even 12%. The yield of the ultrafiltration is dependent on the temperature, and it is preferable to use a temperature between 30° C. and 55° C., and more preferably between 38° C. and 50° C., and even more preferably between 40° C. and 50° C.

In order for the blue mold to be capable of developing, the process comprises at least one aging step, consisting of storing the cheese after needling, preferably at air-conditioned and in particular temperature- and humidity-controlled sites.

In one embodiment, the external surface of said cheese is treated with a liquid medium containing white mold, in particular penicillium candidum and geotrichum candidum.

In an advantageous embodiment of the invention, the blue mold used in the process in accordance with the invention is penicillium roqueforti.

The process can be implemented with milk in particular selected from the group consisting of cow milk, sheep milk, goat milk, buffalo milk, or mixtures between these milks.

In a particularly preferred embodiment, the aging is performed in three successive steps, namely:

(i) for a duration D₁ of between 2 and 4 days at a temperature T_{Ag1} of between 14° C. and 18° C., preferably with relative humidity RH₁ between 85% and 95%, and preferably between 90% and 95%;

(ii) for a duration D₂ of between 5 and 7 days at a temperature T_{Ag2} of between 10° C. and 15° C. (with T_{Ag2}<T_{Ag1}), preferably with relative humidity RH₂>RH₁ and even more preferably between 95% and 99%;

(iii) for a duration D₃ of between 2 and 4 days at a temperature T_{ag3} of between 8° C. and 11° C. (with T_{Ag3}<T_{Ag2}), preferably with relative humidity RH₃>RH₂ and even more preferably between 88% and 95%.

The invention relates secondly to a cheese with blue mold capable of being obtained by the process in accordance with the invention. This cheese is characterized in particular by the presence of a plurality of holes or channels comprising substantially rectilinear cross-sections, resulting from the piercing with suitable instruments, such as needles or a water jet. Said holes or channels may pass through the cheese, advantageously horizontally, and may intersect; a plurality of holes or channels may be parallel and/or may be arranged with a plurality in parallel planes. In said holes or channels, at least over a central portion of their length, a blue mold, preferably abundant, is found, and the cheese does not typically show mold outside of said holes or channels because its unctuous consistency, which results in part from the ultrafiltration process used to create the liquid pre-cheese, does not promote the natural formation of openings during the process. Thus, the cheese in accordance with the invention has very characteristic cutting surfaces that visually distinguish it from the known blue cheeses. In addition, it has an unctuous consistency, associated with the production of the cheese comprising an ultrafiltration step as described above, which also distinguishes it from the known blue cheeses.

### BRIEF DESCRIPTION OF THE DRAWINGS

FIG. 1a illustrates a front view of an example of a holder intended to cooperate with a needling instrument in order to obtain a cheese in accordance with the process of the invention.

FIG. 1b illustrates a top view of the holder in FIG. 1a.

FIG. 1c illustrates a side view of the holder in FIG. 1a.

### DETAILED DESCRIPTION OF EMBODIMENTS

We will describe in detail the various steps, essential and optional, of the process in accordance with the invention.

First, milk is supplied. It can in particular be cow milk, sheep milk, goat milk, buffalo milk or a mixture of these milks. Then, the milk is standardized, i.e., the fat/protein ratio is verified and, as the case may be, adjusted to a desired value. In most cases, this standardization step is intended to increase this ratio, i.e. increase the fat content of the milk. This standardization can be performed in accordance with techniques known to a person skilled in the art, for example by adding cream in accordance with the desired fat content of the fat-enriched milk. The increase in the fat content of the milk leads to a more unctuous, softer end cheese. In a preferred embodiment, the fat content of the milk subjected to ultrafiltration is between 6% and 11%, which typically leads to a protein content of between 2.8% and 3.2%; the final cheese may thus reach a fat content in the milk solids on the order of 60° C. to 70%.

Then, the milk is pasteurized, in accordance with techniques known to a person skilled in the art. Although this step is not strictly necessary for performing the process in accordance with the invention, it is highly preferable that it be implemented in order to improve the preservation of the resulting cheese.

Then, the milk, advantageously pasteurized, is subjected to an ultrafiltration process, which is essential for the process in accordance with the invention. The ultrafiltration breaks down the milk into a retentate and an aqueous permeate. The permeate is an aqueous liquid that comprises soluble salts and lactose of the milk. The retentate resulting from this ultrafiltration step is commonly called “liquid pre-cheese”; it comprises almost all of the proteins and the fat of the milk. This ultrafiltration is advantageously performed at a temperature of between 30° C. and 55° C., preferably between 38° C. and 50° C., and even more preferably between 40° C. and 50° C., because the ultrafiltration yield is optimal in this temperature range.

It is known to a person skilled in the art to obtain liquid pre-cheese by an ultrafiltration process through a ceramic, polysulfone or cellulose acetate membrane; see, for example, the article “Préparation de fromage à partir de ‘préfromage liquide’ obtenu par ultrafiltration du lait” [Preparation of cheese from ‘liquid pre-cheese’ obtained by ultrafiltration of milk] by J. L. Maubois and G. Mocquot, published in the journal Le Lait, no. 508, September-October 1971, pages 495-533. It is also known to use such a pre-cheese to produce cheeses; see, for example, patent FR 2,837,669 (Fromagerie Guilloteau), U.S. Pat. No. 5,912,036 (Celia), patent application GB 2,105,167 (Pasilac A/S) and patent application WO 2005/046344 (P. Elston et al.), but it has not been envisaged to use it to produce cheeses with internal blue mold.

In the process in accordance with the invention, the pasteurized milk may be introduced directly, preferably continuously, in the ultrafiltration process, after cooling from the pasteurization temperature to the ultrafiltration temperature, or the milk may be cooled at a lower temperature for intermediate storage, typically at a temperature of between 1° C. and 4° C., before being heated to the ultrafiltration temperature.

The process in accordance with the invention involves molding of the cheese, so as to give it a shape. Traditionally, to produce cheese, pierced molds are used, which have two functions: they give the cheese a shape, by compressing the curd grains, and they enable the cheese to drain, i.e. the aqueous liquid called “whey” or lactoserum to flow through the holes of the mold.

In the process in accordance with the invention, the ultrafiltration step is intended to separate the permeate, represented by lactoserum, from the retentate, represented by the liquid pre-cheese. It therefore involves reducing the water content of the milk, i.e. concentrating the milk into proteins and fat. Advantageously, the ultrafiltration is a complete ultrafiltration. Advantageously, the concentration ratio is between 3 and 7, i.e. the volume of the pre-cheese obtained corresponds to an amount of between ⅓ and 1/7 of the initial volume of the milk, i.e. the volume of milk subjected to the ultrafiltration process. Preferably, the concentration ratio is between 4 and 7, and even more preferably between 5 and 6.

The retentate, i.e. the liquid pre-cheese resulting from the ultrafiltration process, has a neutral pH that is typically on the order of 6.6. In a vat, it is inoculated with a ferment that converts sugar (lactose) into lactic acid. During this step, which is typically performed in a vat at a controlled temperature T1, the pH decreases. The working temperature T1 is dependent on the ferment used. With a mesophilic ferment, a temperature of between 15° C. and 40° C., preferably between 20° C. and 35° C. and even more preferably between 23° C. and 33° C. is preferred; the pH typically decreases from 6.6 to 4.80. With a thermophilic ferment, a temperature of between 30° C. and 55° C., preferably between 38° C. and 46° C., and even more preferably between 40° C. and 45° C. is used; during this maturation, the pH may decrease to a value of around 4.5.

An intermediate product is thus obtained, to which salt is added, typically around 0.8% by mass. It is also possible to add blue mold at this stage (preferably just before the renneting), or it is possible to introduce the blue mold at a later stage, namely during needling, as explained below.

Then, said intermediate product is introduced into a mold, typically by pouring. This mold does not have draining holes. Before the intermediate product is introduced into the mold, rennet is added, typically by continuous injection in the flow of the intermediate liquid product using a metering pump in a mixing area. In an alternative, the rennet may be added to the mold, but this is industrially less practical.

The addition of rennet is performed at a temperature of between 18° C. and 50° C., and preferably between 35° C. and 41° C. The addition of rennet is performed at a pH of between 4.90 and 6.30, given that the choice of the pH is dependent on the desired texture of the end cheese: a pH close to the upper limit gives a more breaking texture, and a pH close to the lower limit gives a more unctuous cheese.

Any mold shape may be suitable. It is possible to use, for example, a parallelepiped mold with dimensions 48 cm×72 cm×8 cm, with the last parameter representing the thickness, or in a mold with a circular shape with a diameter of around 20 to 25 cm (for example 23 cm) and a height of around 8 cm), or any other suitable shapes or sizes. It is also possible to use molds with a smaller size, as explained below. In the case of larger mold formats, it is possible to cut the cheese into smaller pieces before the needling step.

Then, the product stays in the mold in a coagulation chamber at a controlled temperature T2, with the maturation being terminated upon complete conversion of the lactose into lactic acid. The residence time is dependent on the ferment used and the renneting pH, and may be between 3 h and 15 h. The temperature T2 is advantageously approximately the same as temperature T1. On removal from the coagulation chamber, the pH is between 4.25 and 5.00 and preferably between 4.50 and 4.80. A cheese that is then cooled in the mold at a temperature of between 14° C. and 22° C. is thus obtained.

Then, the cheese is removed from the mold and needled. The needling step consists of piercing holes or channels into the cheese, by any suitable means, and typically by means of needles; these needles advantageously have a conical inlet. This needling step is essential for the process in accordance with the invention because it makes it possible to develop the desired blue mold. Indeed, the blue mold can develop only in contact with air because it needs oxygen. If the blue mold has been introduced into the liquid cheese before it has been poured into the mold, the needling of the cheese creates channels or air inlets enabling the mold to develop in contact with the air, preferably so as to fill, at the end of the aging step, substantially the entire volume of the channels. If the mold has not been introduced into the liquid cheese, it must be introduced during the needling or after the needling, typically by means of a hollow needle that releases an aqueous medium containing the target mold; then, the blue mold is left to develop, preferably so as to fill, at the end of the aging step, substantially the entire volume of the holes or channels.

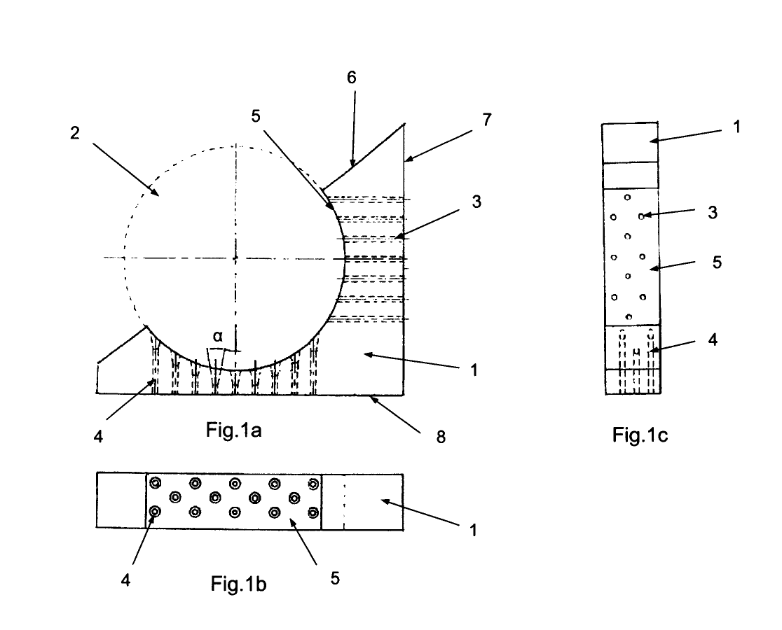

Advantageously, during the needling, a plurality of through-channels with a substantially cylindrical shape are generated. The channels or holes may have any cross-section, in particular circular, square, rectangular, triangular or oblong. In accordance with one embodiment, their diameter (or the largest dimension of their cross-section) is between 3 mm and 10 mm, and preferably between 4 mm and 7 mm. In general, the holes with a size smaller than 3 mm risk being filled with liquid by capillarity when the surface of the cheese is inoculated with white cheese in the liquid phase; given that white mold drives out blue mold, this is not desired. These channels are preferably horizontal with respect to the external shape of the cheese (i.e. parallel to the planar surface on which the cheese rests during its storage), so as to enable harmonious development of the blue mold. This horizontal needling also makes it possible to prevent discharge of the aqueous liquid filled with blue mold, if it is introduced during the piercing, and penetration of the aqueous liquid filled with white mold if it is applied on the external surface of the cheese. In one embodiment, a plurality of channels located in the same plane are produced. Depending on the thickness of the cheese, it is possible to produce channels that are located in two or three parallel planes. An example is shown in FIGS. 1a to 1c.

In a particularly preferred manner, the cheese is needled so that the channels not only pass through but intersect in the cheese. This enables good aeration of the cheese, which promotes the development of the desired blue mold. This also makes it possible to generate visually attractive cutting surfaces. Typically, needling is performed with an instrument having multiple needles.

In a first embodiment, after a first series of needlings in a first position, of the cheese or of the instrument, either the cheese or the instrument is rotated by 90° so as to produce the second series of channels in a second position perpendicular to the first.

It is not advantageous, however, for the channels of the two series to intersect in the same plane, because at least some of the channels then risk being plugged.

In another embodiment, which is preferred, all of the needles are pressed in all of the planes, preferably simultaneously, and they are left pressed for a certain time so that the cheese can dilate; this prevents the channels from closing back up after the needles are removed.

In general, it is important in the process in accordance with the invention for the channels not to be plugged, so as to enable harmonious and complete development of the blue mold inside the cheese. In this context, and in consideration of the particular and unctuous consistency of the cheese developed from a liquid pre-cheese obtained by complete ultrafiltration of a milk optionally enriched with cream, the shape and diameter of the needles as well as the precise piercing operation may play an important role. The inventor has noted that channels pierced with needles having a diameter smaller than 3 mm risk being plugged, in particular for cheeses of a certain size. For this reason, a nominal diameter of the hole of at least 3.5 mm is preferred. The term “nominal diameter” is used here to refer to the external diameter of the needle; indeed, the insertion of the needle dilates the cheese, and the removal of the needle leads to a relaxation of the cheese: the diameter of a hole after the needle has been removed is always smaller than the diameter of the needle. An excessively large needle, however, will cause the cheese to collapse. For this reason, a nominal diameter that does not exceed 7 mm, and even more preferably that does not exceed 6.5 mm, is preferred. For larger cheeses, a needle diameter of between 4.0 and 6.0 mm is thus preferred. Advantageously, the needles are not pointed.

In addition, the inventor has noted that, in the particular case of a cheese formed using a liquid pre-cheese obtained by complete ultrafiltration of milk previously enriched by adding cream, the holes have less of a tendency to become plugged if there is a pause of several seconds between the complete introduction of a needle, of a group of needles or (preferably) of all of the needles and the start of their removal. In a typical embodiment, this pause is between 1 s and 15 s, preferably between 5 s and 10 s. In an embodiment described here as an example, all of the needles are introduced in a plane at the same time, there is a pause of several seconds, then all of the needles are removed at the same time (embodiment called “with needles at rest after piercing”). It is also possible to pause for all of the needles at the same time in the cheese, and this is preferred.

FIGS. 1a to 1c illustrate an example of a holder 1 intended to cooperate with a needling instrument, as will be explained below. The holder 1 enables the needling needles to be guided when the penetrate the cheese. The cheese 2 (shown with dotted lines in FIG. 1a) is held by the holder 1 during needling with needles passing through the holes of the holder. The cheese 2 shown in FIG. 1 has a cylindrical shape and is arranged vertically, resting with its base on a horizontal bearing plate (not shown in the drawings). The holder 1 has a square shape with a thickness at least equal to that of the cheese to be needled. The oblique portion 6 of the holder 1 has a recess 5 with a hemi-cylindrical shape wherein the cheese 2 is arranged, with the shape of the recess being adapted to that of the cheese to be needled. The first side 7 of the holder 1 has a first series of through-holes 3 intended to guide a first series of needles (not shown in the drawings). The second side 8, perpendicular to the first side 7 of the holder 1, has a second series of through-holes 4 intended to guide a second series of needles (not shown in the drawings). The first series of through-holes 3 comprises a plurality of holes with parallel axes arranged in a staggered manner. In the example of the appended figures, the first series of through-orifices 3 is formed with a first row of three holes, followed by a second row of four holes, then a third row of three holes. The second series of through-holes 4 comprises a plurality of holes with parallel axes arranged in a staggered manner, with the axes of the through-holes 4 being perpendicular to the axes of the through-holes 3. The second series of through-holes 4 comprises a first row of 5 holes, followed by a second row of four holes, then a third row of five holes. The holes 4 have a flared portion of angle α (for example, equal to 20°) enabling better guiding of the needles.

The diameter of the through-holes 3 and 4 is slightly greater than that of the needles so as to enable both good guiding and a passage with low clearance, of around 0.1 mm, of the latter.

In the example illustrated in FIGS. 1a to 1c, the spacing and the number of holes are different on the two sides 7 and 8 of the holder 1. In other examples (not shown), it is possible to have the same number of holes on each side of the holder. In yet another example (not shown), it is possible to have holes on only one side of the holder 1.

The needles are held by a rectangular plate caused to move in a horizontal plane, perpendicularly to the longitudinal axis of the cheese as installed in the holder 1. The needles have a predetermined length that must be greater than the diameter (or the thickness) of the cheese through which they pass. The needles have a conical leading portion. The number of needles, their arrangement in parallel rows or staggered, as well as their diameter (which corresponds to that of the channels produced in the cheese) are dependent on the dimensions of the cheese to be needled and the amount of blue mold to be obtained.

In another example embodiment, the holder 1 is arranged with its side 8 on a horizontal surface and forms a bearing for cheese 2 arranged horizontally.

Several examples will be provided here for the needling of cheeses of different sizes.

Cylindrical cheese with a diameter of 23 cm and a height (thickness) of 4.5 cm: two times three rows of channels arranged in a staggered manner are produced, with the rows comprising respectively 7, 6 and 7 channels pierced horizontally and at 90° so that they intersect inside the cheese (see FIG. 1), or, preferably, on two different planes so that they do not intersect.

Parallelepiped cheese with dimensions: 12 cm×12 cm, thickness 4.5 cm: two times three rows of channels arranged in a staggered manner are produced, with the rows comprising respectively 4, 3 and 4 channels pierced horizontally and at 90° so that they intersect inside the cheese, or, preferably, on two different planes so that they do not intersect.

Parallelepiped cheese with dimensions: 6 cm×6 cm, thickness 4.5 cm: two times three rows of channels arranged in a staggered manner are produced, with the rows comprising respectively 2, 1 and 2 channels pierced horizontally and at 90° so that they intersect inside the cheese, or, preferably, on two different planes so that they do not intersect.

Cubical cheese with dimensions: 3 cm×3 cm×3 cm: two channels are produced: one pierced horizontally and one pierced at 90°, preferably without intersection.

In accordance with a particular embodiment of the invention, the channels are not pierced mechanically but by means of a water jet. This mode of piercing involves the particularity that the material pierced is continuously removed during the piercing, and the risk of plugging of the channels after the piercing is therefore lower, even if there is an intersection in the same plane. It can be applied to any type of cheese in accordance with the invention. It is particularly preferred for cheeses based on sheep milk or goat milk, because these cheeses are denser than cheese based on cow milk.

In an alternative of the process in accordance with the invention, which can be combined with any other embodiment, after the needling, an aqueous medium containing white mold is applied on the external surface of the cheese, in order to confer on the external surface of the cheese a white and dry cover, which is desired by certain consumers. If the blue mold has been introduced into the liquid cheese, the white mold must be applied on the external surface of the cheese removed from the mold at most around ten hours after the needling, because otherwise the white mold will not develop.

The final step of the process is aging, i.e. storage of the cheese under controlled temperature and humidity conditions so as to enable the mold to develop; aging is known to be essential for the gustatory and olfactory qualities of a pasteurized cheese. In one embodiment of the process in accordance with the invention, the aging is performed at a temperature of between 8° C. and 18° C., preferably the temperature does not exceed 16° C., at relative humidity of at least 80% and preferably at least 85% for at least one aging portion. Very preferably, the aging is performed in a plurality of steps.

An advantageous aging process is performed in three successive steps, defined as follows:

(i) for a duration D₁ of between 2 and 4 days at a temperature T_{Ag1} of between 14° C. and 18° C., preferably with relative humidity RH₁ between 85% and 95%, and preferably between 90% and 95%;

(ii) for a duration D₂ of between 5 and 7 days at a temperature T_{Ag2} of between 10° C. and 15° C. (with T_{Ag2}<T_{Ag1}), preferably with relative humidity RH₂>RH₁ and even more preferably between 95% and 99%;

(iii) for a duration D₃ of between 2 and 4 days at a temperature T_{Ag3} of between 8° C. and 11° C. (with T_{Ag3}<T_{Ag2}), preferably with relative humidity RH₃>RH₂ and even more preferably between 88% and 95%.

In an especially preferred three-step aging process, the following parameters are used:

(i) D₁=2.5 to 3.5 days, T_{Ag1}=15° C. to 16.5° C., RH₁=90% to 95%;

(ii) D₂=5 to 7 days, T_{Ag2}=11° C. to 13° C., RH₂=95% to 99%; and

(iii) D₃=2.5 to 3.5 days, T_{Ag3}=8° C. to 10° C., RH₃=88% to 95%.

The inventor found that the use of a liquid pre-cheese resulting from an ultrafiltration process leads to an unctuous blue cheese, with a high protein and calcium content; this calcium content stabilizes the aroma of the aged cheese, enabling prolonged storage of the packaged cheese without loss of its organoleptic qualities.

In addition, by comparison with the processes commonly used to produce blue cheese, the process in accordance with the invention enables better enrichment of the milk. Indeed, the protein content of the permeate (lactoserum) is very low, with almost all of the proteins being contained in the retentate and converted into cheese. In addition, for a given quality of cheese produced, the process consumes less rennet than the known processes.

### EXAMPLES

This example relates to the production of a blue cheese with 60% fat in the milk solids, using the process in accordance with the invention.

The raw milk was standardized into fat with twice the protein content. The protein content was 32 grams per liter; therefore, the fat was brought to 64 grams per liter by adding cream. The standardized milk was then pasteurized at 80° C. for 4 seconds, followed by cooling at 3° C. of the pasteurized milk for its intermediate storage. This milk was then heated to 40° C., introduced into a four-stage ultrafiltration device, then by ultrafiltration a concentration with a factor of 4.5 was produced to obtain a retentate (liquid pre-cheese) having the following composition: fat=288 g/l (or 64 g/l×4.5); protein=144 g/l (or 32 g/l×4.5).

This liquid pre-cheese was then cooled to 30° C. in a maturation vat, and inoculated with mesophilic ferments, while constantly monitoring the pH. When the pH reached a value of 6.30, the salt (around 0.8% by mass) and the blue mold were added, and this pre-cheese was renneted into suitable molds. These molds were then placed in a coagulation chamber where they were kept for 10 hours at 30° C. After 10 hours, the cheese had set, and it was placed with its mold in a cooling chamber where it was cooled at between 22° C. and 14° C.

Then, the cheese was removed from the mold and immediately needled. It was left to dry for around two hours, then an aqueous solution (or, in an alternative, the pre-cheese) inoculated with white yeast was sprayed so as to obtain a white cover.

The aging was performed in three steps, as follows:

3 days at 16° C., hygrometry 90-95% relative humidity;

6 days at 16° C., hygrometry 90-99% relative humidity; and

3 days at 19° C., hygrometry 88-95% relative humidity.

At the end of this aging sequence, the cheese was tasted and considered good.

In a very similar example, for a cylindrical cheese with a diameter of 23 cm, the embodiment described above (including an intersection of channels) was compared with an embodiment of the “needles at rest after piercing” type, performed without intersection of channels. After maturation, the channels were opened in the direction of their lengths to assess the degree of development of the blue mold. It was found that the blue mold content, expressed as a fraction of the length of the channels filled with blue mold with respect to the total length of the channels, went from around 40% or 50% (with a certain fluctuation) to a value of between 80% and 90%.

1-16. (canceled)

17. A process of producing a molded cheese with internal blue mold using milk, the process comprising:
subjecting the milk to an ultrafiltration process that separates the milk into an aqueous permeate and a retentate, until a liquid pre-cheese retentate is obtained, of which the volume is reduced to at least ⅓ of the volume of the milk subjected to the ultrafiltration;
inoculating the liquid pre-cheese retentate with a ferment which at least partially converts lactose in the liquid pre-cheese retentate into lactic acid;
adding rennet to coagulate and thereby obtain a cheese;
after removing a mold, needling the cheese by piercing a plurality of holes to enable a blue mold to develop; and then
introducing blue mold in the cheese.

18. The process of claim 17, further comprising, before subjecting the milk to an ultrafiltration process, enriching the milk with fat having a fat content of between 6% and 11%.

19. The process of claim 17, wherein at least some of the holes intersect.

20. The process of claim 17, wherein the holes are pierced horizontally.

21. The process of claim 17, further comprising, after needling the cheese, aging the cheese by storing the cheese under controlled temperature and relative humidity conditions, so as to enable the blue mold to develop.

22. The process of claim 17, wherein the diameter of the holes is between 4 mm and 7 mm.

23. The process of claim 17, further comprising treating the surface of the cheese with a liquid medium containing white mold.

24. The process of claim 17, wherein the ultrafiltration process is performed at a temperature of between 40° C. and 50° C.

25. The process of claim 17, wherein the milk is selected from the group consisting of cow milk, sheep milk, goat milk, buffalo milk and mixtures thereof.

26. The process of claim 17, wherein the needling is performed using needles having a diameter between 3.5 mm and 6.5 mm.

27. The process of claim 26, wherein, after inserting of at least one needle, there is a pause of between 1 s and 10 s before removing the at least one needle.

28. The process of claim 26, wherein needling the cheese is performed using a water jet.

29. The process of claim 21, wherein aging the cheese comprises:
aging the cheese for a first duration of between 2 and 4 days at a first temperature of between 14° C. and 18° C. and at a first relative humidity of between 85% and 95%; and then
aging the cheese for a second duration of between 5 and 7 days at a second temperature which is less than the first temperature and at a second relative humidity which is greater than the first relative humidity; and then
aging the cheese for a third duration of between 2 and 4 days at a third temperature which is less than the second temperature and at a third relative humidity which is greater than the second relative humidity.

30. A cheese with internal blue mold using milk, cheese obtained using a process comprising:
subjecting the milk to an ultrafiltration process that separates the milk into an aqueous permeate and a retentate, until a liquid pre-cheese retentate is obtained, of which the volume is reduced to at least ⅓ of the volume of the milk subjected to the ultrafiltration;
inoculating the liquid pre-cheese retentate with a ferment which at least partially converts lactose in the liquid pre-cheese retentate into lactic acid;
adding rennet to coagulate and thereby obtain a cheese;
after removing mold, needling the cheese by piercing a plurality of holes to enable a blue mold to develop; and then
introducing blue mold in the liquid pre-cheese retentate or in the holes of the cheese.

31. The cheese of claim 30, wherein the plurality of holes are filled at least over a central portion of their length with blue mold.

32. The cheese of claim 31, wherein the holes are parallel to the planar surface on which the cheese rests during storage.

33. A process of producing cheese comprising:
subjecting pasteurized milk to an ultrafiltration process until a liquid pre-cheese retentate is obtained, of which the volume is reduced to at least ⅓ of the volume of the pasteurized milk subjected to the ultrafiltration;
inoculating the liquid pre-cheese retentate with a ferment;
obtaining a cheese form by adding rennet to coagulate the liquid pre-cheese retentate;
piercing a plurality of channels in the cheese to enable a blue mold to develop; and then
introducing blue mold in the channels.

34. The process of claim 33, further comprising, after piercing a plurality of channels in the cheese, aging the cheese.

35. The process of claim 34, wherein aging the cheese comprises:
aging the cheese for a first duration of between 2 and 4 days at a first temperature of between 14° C. and 18° C. and at a first relative humidity of between 85% and 95%; and then
aging the cheese for a second duration of between 5 and 7 days at a second temperature which is less than the first temperature and at a second relative humidity which is greater than the first relative humidity; and then
aging the cheese for a third duration of between 2 and 4 days at a third temperature which is less than the second temperature and at a third relative humidity which is greater than the second relative humidity.

36. The process of claim 33, further comprising treating the surface of the cheese with a liquid medium containing white mold.
